(19) United States
(12) Patent Application Publication
(10) Pub. No.: US 2014/0191760 A1
(43) Pub. Date: Jul. 10, 2014

(54) METHOD AND APPARATUS FOR SUPPRESSION OF THE AIRWAVE IN SUBSEA EXPLORATION

(71) Applicant: Bentsion Zinger, Oslo (NO)

(72) Inventor: Bentsion Zinger, Oslo (NO)

(21) Appl. No.: 14/157,542

(22) Filed: Jan. 17, 2014

(51) Int. Cl. G01V 3/12

(52) U.S. Cl. CPC G01V 3/12
USPC 324/334

(57) ABSTRACT

The far zone “airwave” that arises when surveying subsea formations is greatly diminished by deployment of the transmitter combining mutually orthogonal horizontal electric and magnetic dipoles with the electric and magnetic dipole moments being locked in a special relationship. At each of the operating frequencies, the amplitude and phase characteristics of the transmitter electric and magnetic dipole moments are determined either from a supplementary measurement earned out using natural and/or controlled field sources, or by minimization of the vertical magnetic field at a remote receiver. Similar results can be obtained when data acquired in two independent surveys—one with the horizontal electric dipole transmitter pointing in one direction and another with a horizontal magnetic dipole transmitter pointing in the orthogonal direction and towed over the same or close positions—are linearly combined to minimize the vertical component of the combined magnetic field at remote receivers.

### OTHER PUBLICATIONS

References Cited
U.S. PATENT DOCUMENTS

| | | |
|---|---|---|
| 3,052,836 A | September 1962 | Postma |
| 4,047,098 A | September 1977 | Duroux |
| 4,078,510 A | March 1978 | Morgan |
| 4,617,518 A | October 1986 | Srnka |
| 4633,182 A | December 1986 | Dzwinel |
| 4,862,089 A | August 1989 | Sigal |
| 5,825,188 A | October 1998 | Montgomery et al. |
| 6,236,211 B1 | May 2001 | Wynn |
| 6,696,839 B2 | February 2004 | Ellingsrud et al. |
| 6,717,411 B2 | April 2004 | Ellingsrud et al. |
| 6,859,038 B2 | February 2005 | Ellingstud et al. |
| 7,002,350 B1 | February 2006 | Barringer |
| 0,038,570 A1 | February 2006 | Constable |
| 7,109,712 B2 | September 2006 | Constable |
| 0,186,889 A1 | August 2006 | Andreis |
| 7,529,627 B2 | May 2009 | Lisitsyn et al. |
| 7,884,612 B2 | November 2011 | Conti et al. |

FOREIGN PATENT DOCUMENTS

| | | |
|---|---|---|
| EP | 1309887 | March 2004 |
| EP | 1256019 | June 2004 |
| GB | 2070345 | September 1981 |
| GB | 2385923 | September 2003 |
| GB | 2390904 | January 2004 |
| GB | 2404444 | February 2005 |
| WO | 014906 | February 2002 |
| WO | 100467 | December 2003 |
| WO | 104844 | December 2003 |
| WO | 109338 | April 2004 |
| WO | 081016 | February 2005 |
| WO | 010560 | February 2005 |
| WO | 052145 | May 2006 |

Amundsen, L., L. et al., Decomposition of Electromagnetic Fields into Upgoing And Downgoing Components, Geophysics, vol. 71, No. 5, September 2006, pp. G211-G223.
Andréis, ft et al., Controlled-Source Electromagnetic Sounding in Shallow Water: Principles and Applications. Geophysics, vol. 73, No. 1, January-February 2008, pp. F21-F32.
Boerner, D. E. et al., Orthogonality in CSAMT and MT Measurements, Geophysics, vol. 58, No. 7, July 1993, pp. 924-934.
Chave, A. D. et al., Controlled Electromagnetic Sources for Measuring Electrical Conductivity Beneath the Oceans, Journal of Geophysical Research, vol. 87, No. B7, Jul. 10, 1982, pp. 5327-5338.
Chave, A. D. et al., Electrical Exploration Methods in Applied Geophysics vol. 2, Electrical Exploration Methods for the Seafloor, Chapter 12, 1991, pp. 931-966.
Chen, J. et al., Three Methods for Mitigating Airwaves in Shallow Water Marine Controlled-Source Electromagnetic Data Geophysics, vol. 76 No. 2, March 2011, pp. F89-F99.
Constable, S. et al., Marine Controlled-Source Electromagnetic Sounding, Journal of Geophysical Research, vol. 101, No. B3, March 1996, pp. 5519-5530.
Constable, S. et al., An Introduction to Marine Controlled-Source Electromagnetic Methods for Hydrocarbon Exploration, Geophysics, vol. 72. No. 2, March 2007, pp. WA.3-WA12.
Constable, S., Ten Years of Marine CSEM for Hydrocarbon Exploration, Geophysics, vol. 75, No. 5, September 2010, pp. A67-A81,
Edwards, R. N., On the Resource Evaluation of Marine Gas Hydrate Deposits Using Sea-Floor Transient Electric Dipole-Dipole Methods, Geophysics vol. 62, No. 1, January 1997, pp. 63-74,
Edwards, R. N., Marine Controlled Source Electromagnetics: Principles, Methodologies, Future Commercial Applications, Surveys in Geophysics, vol. 26, No. 6, November 2005, pp. 675-700.
Evans, Rob L. et al., On the Electrical Nature of the Axial Melt Zone at 13 Degrees N on the East Pacific Rise, Journal of Geophysical Research, vol. 99, No. B1, Jan. 10, 1994, pp. 577-588.
Fan, Y. R. et al.. Increasing the Sensitivity of Controlled-Source Electromagnetics with Synthetic Aperture, Geophysics, vol. 77, No. 2, March 2012, pp. E135-E145.
Flosadottir, A. et al., Marine Controlled-Source Electromagnetic Sounding, journal of Geophysical Research, vol. 101, No. B3, Mar. 10, 1996, pp. 5507-5517.
MacGregor, L. et al., The Rarnesses Experiment-III. Controlled Source Electromagnetic Sounding of the Reykjanes Ridge at 57°45′N, Geophys. J. Int., vol. 135, No. 3, September 1998, pp. 773-789,
MacGregor, L. et al.. Use of Marine Controlled-Source Eleetromapetic Sounding for Sub-Basalt Exploration, Geophysical Prospecting, vol. 48. No. 6 , November 2000, pp. 1091-1106.
Nekut, A., Petroleum Exploration Using Controlled-Source Electromagnetic Methods, Proceedings of the IEEE, vol. 77, No. 2, February 1989, pp. 338-362.
Nordskag, J. I. et al., Asymptotic Airwave Modeling for Marine Controlled-Source Electromagnetic Surveying, Geophysics, vol. 72. No. 6, November 2007, pp. F249-F255.
Sinha, M. et al., An Active Source Electromagnetic Sounding System for Marine Use, Marine Geophysical Researches 1990, 12: 59-68.
Sinha. M. e. et al., Evidence for Accumulated Melt Beneath the Slow-Spreading Mid-Atlantic Ridge, Phil. Trans. R. Soc. Land. A, 355, 1997, pp. 233-253.
Urn, E. et al,, On the Physics of the Marine Controlled Source Electromagnetic Method, Geophysics, vol. 72, No. 2, March 2007, pp. WA13-WA26.
Ward, S.H. et al., Electromagnetic Theory for Geophysical Applications, in investigations in Geophysics: Electromagnetic Methods in Applied Geophysics, ed. Nabighian, Society of Exploration Geophysicists, Oklahoma, 1988.
Weidelt, Peter, Guided Waves in Marine CSEM, Geophysical Journal international, v. 171, No. 1, October 2007, pp. 153-176.
Yuan, J. et al., The Assessment of Marine Gas Hydrates through Electrical Remote Sounding: Hydrate without a BSR?, Geophysical Research Letters, vol. 27, August 2000, pp. 2397-2400.

### CROSS-REFERENCE TO RELATED APPLICATIONS

Not applicable.

### STATEMENT REGARDING FEDERALLY SPONSORED RESEARCH OR DEVELOPM EN I

Not applicable.

### BACKGROUND OF INVENTION

1. Field of Invention

The invention relates to surveying of subsea formations especially for purpose of detection and evaluation of oil and gas reservoirs.

2. Background Art

Controlled-source electromagnetics (CSEM) has been widely used to delineate and evaluate oil and gas reservoirs in underwater formations. In such surveys the field is typically induced by an electric dipole, i.e. two electrodes towed behind the vessel at the distance of several dozen meters above the seabed. The electric current is injected into the sea through these two electrodes; the source dipole is oriented in the direction of the vessel movement and connected to a powerful generator on-board the vessel via an umbilical cable. The induced electromagnetic field is measured by receivers towed behind the same or another vessel, or by receivers placed on the seabed. The seabed receivers may be allocated along a profile crossing the surveyed area or, preferably, along a set of such profiles. The injected electric current typically varies with time as a sequence of periodic pulses but the data acquisition and processing are usually limited by several operating frequencies in the range 0.01 to 10 Hz. The spatial distribution of the components of the electromagnetic field measured by the receivers is used to derive conclusions about the subsea formation. As in borehole geophysics, marine CSEM makes use of the fact that displacement of the ground water in pores by hydrocarbons increases resistivity of the reservoir rocks.

The electromagnetic field induced in a conductive medium can be described in terms of two scalar potentials. One of the potentials describes the electromagnetic field with the electric field being purely horizontal—this part of the field is referred to as the transverse electric (TE) field or mode. Another potential describes the electromagnetic field with the magnetic field being purely horizontal—this part of the field is called the transverse magnetic (TM) field of mode. In a stratified medium, each of these potentials satisfies an equation independent of another potential. Most of the controlled sources create the electromagnetic field composed of both modes. The only exceptions are the vertical magnetic dipole (VMD), which induced in the stratified medium only the TE-field, and the vertical electric dipole (VED), which induces only the TM-field. The nearest practical approximations to these sources are a horizontal current loop and a submerged vertical electric cable, respectively.

The two modes of the field are characterized by very different geometrical patterns of the electric current flow. Currents of the TE-mode flow horizontally. They do not cross the horizontal boundaries between the layers. In the TE-field coupling between adjacent layers is purely inductive. As a result, the TE-field may be affected by a layer characterized by higher than the surrounding conductivity even if such a layer is relatively thin. On the other hand, the TE-mode remains largely insensitive to resistive thin layers, even if they are practically non-conductive. Unlike the TE-mode, electric currents of the TM-mode cross the boundaries between the layers. This makes the TM-mode sensitive to resistive layers, even to the relatively thin ones. Moreover, the magnetic field of the TM-mode does not propagate in non-conductive layers (e.g., the air half-space) at all. While decoupled inside the source-free stratified formation, the two modes are couples at the source. In a realistic survey, the modes are also coupled at the lateral inhomogeneities. Rigorously speaking, this means that any factor affecting one of the field modes may also be expected to affect the other. Nevertheless, the effect of resistive layers or intrusions on the M-field represents a direct effect, which is usually stronger than the indirect effect on the TE-field.

The non-conductive air space differently affects the two modes of the electromagnetic field. While the TM-field still decays exponentially, though faster than in a fully conductive space, as the horizontal separation from the source (offset) increases, the TE-field, which propagates in the non-conductive air, diminishes in a slower geometrical manner. Despite the fact that at frequencies used in marine CSEM the field propagation is of a rather diffusive than wave nature, the part of the field, characterized by the geometrical dependence on the offset, is usually described as an “airwave”. This terminology is somewhat questionable but widely used in the literature as a matter of convenience.

The CSEM targets subsea reservoirs partially filled with hydrocarbons, which make such reservoirs more resistive than the surrounding formation. The electromagnetic field acquired at a given operation frequency is usually analyzed as a function of the horizontal source-receiver separation. Typically, the “signature” of a resistive reservoir appears at an offset, which is two to five times larger than the depth of the reservoir measured from the sea floor. The CSEM technology is more efficient in a deep sea because the airwave dominance starts at offsets that are larger than that of the reservoir signature. In a shallow sea, the airwave often masks the signature of the reservoir. Thus, the airwave reduces sensitivity of the CSEM data to resistive reservoirs, and, consequently, the depth at which such reservoirs can be detected.

Approaches suggested for mitigating the sensitivity deterioration caused by the airwave usually use subtraction of the somehow evaluated airwave from the measured signal. Such data processing is equivalent to two signals of close amplitudes and phases being subtracted from one another in order to uncover the smaller “airwave-free” signal. The result of this subtraction has a poorer signal-to-noise ratio compared to that of the raw signal. Therefore, such an approach may result in a poor evaluation or non-detection of the reservoir. To some extent, this comment is also applicable to the “decomposition into upgoing-downgoing components” and “synthetic aperture” techniques.

### SUMMARY OF INVENTION

It is the purpose of this invention to suggest a transmitter, which induces the electromagnetic field with a greatly diminished airwave, the procedure for the transmitter tuning up, and the use of the transmitter for surveying the subsea formation. An alternative approach, which is somewhat less efficient but logistically easier, may be implementing by processing two independent sets of data acquired for the same or close transmitter and receiver positions but with different types of transmitters.

The first aspect of the invention relates to a combined field source consisting of at least two major components, one of the components represents an electric dipole and another is a loop (or a coil) characterized by the magnetic dipole moment with its horizontal component being orthogonal to the horizontal component of the current dipole moment of the electric dipole. At each operating frequency, the current and magnetic moments of the combined source are interrelated in a manner minimizing the vertical component of the magnetic field at remote from the source locations.

The second aspect of the invention relates to an alternative implementation of the first aspect of the invention. In accordance with this aspect of the invention, the data set acquired using an electric dipole type of the transmitter are combined with the data set acquired using a magnetic dipole type of the transmitter. The transmitter and receiver horizontal locations used in the second data set are the same or close to that of the first data set. The horizontal components of the current dipole moment of the transmitter used to acquire the first data set and the magnetic moment of the transmitter used to acquire the second data set are mutually orthogonal. The two data sets are combined in a manner minimizing the vertical component of the combined magnetic field at large offsets. The interpretation relies on the combined data set.

Other advantages and important points of the invention are presented in the following figures, descriptions, and claims.

### BRIEF DESCRIPTIONS OF DRAWINGS

FIG. 1 shows a prior art marine surveying using an electric dipole as the transmitter.

FIG. 2 shows a transmitter combining electric and magnetic type sources and a remote receiver acquiring the vertical component of the magnetic field in accordance with one embodiment of the invention.

FIG. 3 shows the plan view indicating mutual orientation of the current and magnetic moments of the combined field source and the position of the feedback receiver (other receivers can be arbitrarily allocated in accordance with the needs of the survey—not shown).

FIG. 4A shows a stratified earth model used for testing the method of this invention in accordance with one embodiment of the invention.

FIG. 4B shows the amplitude of the simulated in-line components of the electric fields that would be measured at the sea floor above two underwater formations, one with and another without a resistive reservoir as sketched in FIG. 4A. The electric fields induced by an in-line horizontal electric dipole in two formations are compared with the fields induced by a source consisting of horizontal electric and magnetic dipoles oriented and tuned in accordance with one embodiment of the invention.

FIG. 4C shows the phase of the simulated in-line components of the electric fields that would be measured at the sea floor above two underwater formations, one with and another without a resistive reservoir as sketched in FIG. 4A. The electric fields induced by an in-line horizontal electric dipole in two formations are compared with the fields induced by a source consisting of horizontal electric and magnetic dipoles oriented and tuned in accordance with one embodiment of the invention.

FIG. 4D shows the amplitude of the simulated vertical components of the magnetic fields that would be measured at the sea floor by off-line receivers above the underwater formation sketched in FIG. 4A. The vertical component of the magnetic field induced by a horizontal electric dipole is compared with that of the field induced by a source consisting of horizontal electric and magnetic dipoles oriented and tuned in accordance with one embodiment of the invention.

FIG. 5A shows an earth model with variable bathymetry used for testing the method of this invention in accordance with one embodiment of the invention.

FIG. 5B shows the amplitude of the simulated in-line components of the electric fields that would be measured at the sea floor above two underwater formations, one with and another without a resistive reservoir as sketched in FIG. 5A. The electric fields induced by an in-line horizontal electric dipole in two formations are compared with the fields induced by a source consisting of horizontal electric and magnetic dipoles oriented and tuned in accordance with one embodiment of the invention.

FIG. 5C shows the phase of the simulated in-line components of the electric fields that would be measured at the sea floor above two underwater formations, one with and another without a resistive reservoir as sketched in FIG. 5A. The electric fields induced by an in-line horizontal electric dipole in two formations are compared with the fields induced by a source consisting of horizontal electric and magnetic dipoles oriented and tuned in accordance with one embodiment of the invention.

FIG. 6A shows an earth model with a square reservoir used for testing the method of this invention in accordance with one embodiment of the invention.

FIG. 6B shows the amplitude of the simulated in-line components of the electric fields that would be measured at the sea floor above two underwater formations, one with and another without a resistive reservoir as sketched in FIG. 6A. The electric fields induced by an in-line horizontal electric dipole in two formations are compared with the fields induced by a source consisting of horizontal electric and magnetic dipoles oriented and tuned in accordance with one embodiment of the invention.

FIG. 6C shows the phase of the simulated in-line components of the electric fields that would be measured at the sea floor above two underwater formations, one with and another without a resistive reservoir as sketched in FIG. 6A. The electric fields induced, by an in-line horizontal electric dipole in two formations are compared with the fields induced by a source consisting of horizontal electric and magnetic dipoles oriented and tuned in accordance with one embodiment of the invention.

### DETAILED DESCRIPTION

The electromagnetic fields induced in a stratified medium by a horizontal electric dipole (HED) bears significant similarities to the field induced by a horizontal magnetic dipole (HMD). At large offsets the TE-mode of the field induced by a HED decays in accordance with the same geometrical law as that of the field induced by a HMD. Therefore, a transmitter, which combines electric and magnetic dipole types of the sources, may induce an electromagnetic field with a significantly reduced TE-mode provided the corresponding current and magnetic dipole moments are properly oriented and tuned up. Such tuning up also reduces the airwave without suppressing the TM-pan of the induced field, which is sensitive to thin resistive layers present in the formation. The vertical component of the magnetic field may be used to control the level of the airwave suppression because the vertical component of the magnetic field, like the airwave, is contributed only by the TE-mode. For simplicity, we consider below an isotropic media. Corresponding generalizations are straightforward and do not affect the description and claims.

A Cartesian coordinate system with the XOY-plane coinciding with the water surface and the OZ-axis directed downwards is used below. The receiver radius vector r=r_{y}+zeₜ, where rᵣ=×eₓ+ye_{y} is the horizontal radius vector, e_{z} is the vertical, and eₓ e_{y} are the horizontal unit vectors of the coordinate system. The implied time factor is e^{-iωt}.

Assuming that a periodic HED with the current moment p=pₓeₓ+p_{y}e_{y} is located at the vertical axis of the coordinate system, the radial_{;} azimuthal_{;} and vertical components of the electric field induced in the far zone of the source (r_{y}>>|λₑ|) are

$${E}_{r} ( r ) ≃ \{ - ω {μ}_{0} \frac{{λ}_{e}^{2} ( z )}{2 π {r}_{τ}^{3}} - \frac{{[ {Z}_{0}^{u} ( z ) ]}^{2}}{2 π T ( z )} {K}_{1}^{′} ( \frac{{r}_{τ}}{{λ}_{m} ( z )} ) \} {p}_{r} \\ {E}_{ϕ} ( r ) ≃ \{ + ω {μ}_{0} \frac{{λ}_{e}^{2} ( z )}{2 π {r}_{τ}^{3}} - \frac{{[ {Z}_{0}^{u} ( z ) ]}^{2}}{ T ( z )} \frac{{λ}_{m} ( z )}{2 π {r}_{τ}} {K}_{1} ( \frac{{r}_{τ}}{{λ}_{m} ( z )} ) \} {p}_{ϕ} \\ {E}_{z} ( r ) ≃ \frac{1}{2 π {λ}_{m} ( z )} \frac{{Z}_{0}^{u} ( z )}{σ ( z ) T ( z )} {K}_{1} ( \frac{{r}_{τ}}{{λ}_{m} ( z )} ) {p}_{r} , \qquad ( 1 )$$

where the current moment of the HED is expressed as p=pᵣeᵣ+p_{φ}e_{φ};

$${e}_{r} = \frac{{r}_{τ}}{{r}_{τ}} , \\ {e}_{ϕ} = {e}_{z} \times {e}_{r} ,$$

and pᵣ=+pₓ cos φ+p_{y} sin φ, p_{φ}=−pₓ sin φ+p_{y} cos φ. Hence, pᵣ is the projection of the current dipole moment p onto the direction of r_{τ}, and p_{φ} is the projection of p onto the orthogonal to r_{τ} horizontal direction. The horizontal component of the electric field Eᵣ=Eᵣeᵣ+E_{φ}e_{φ}. Likewise, the radial, azimuthal, and vertical components of the magnetic field are

$${H}_{r} ( r ) ≃ \{ {υ}_{0}^{d} ( z ) \frac{{λ}_{e}^{2} ( z )}{π {r}_{τ}^{3}} - \frac{{Z}_{0}^{u} ( z )}{T ( z )} \frac{{λ}_{m} ( z )}{2 π {r}_{τ}} {K}_{1} ( \frac{{r}_{τ}}{{λ}_{m} ( z )} ) \} {p}_{ϕ} \\ {H}_{ϕ} ( r ) ≃ \{ {υ}_{0}^{d} ( z ) \frac{{λ}_{e}^{2} ( z )}{2 π {r}_{τ}^{3}} + \frac{{Z}_{0}^{u} ( z )}{2 π T ( z )} {K}_{1}^{′} ( \frac{{r}_{τ}}{{λ}_{m} ( z )} ) \} {p}_{r} \\ {H}_{z} ( r ) ≃ - \frac{3 {λ}_{e}^{2} ( z )}{2 π {r}_{τ}^{4}} {p}_{ϕ} , \qquad ( 2 )$$

and the horizontal component of the magnetic field H_{τ}=Hᵣeᵣ+H_{φ}e_{φ}.

In equations (1) and (2), K₁(.) and K ₁′(.) denote respectively the modified Bessel function of the second kind of order 1 and its derivative. Parameters

$$\begin{matrix}{λ}_{e} ( z ) = - \frac{1}{ ω {μ}_{0} {v}_{0} ( z )} \frac{{Z}_{0}^{u} ( z ) {Z}_{0}^{d} ( z )}{{Z}_{0}^{u} ( z ) + {Z}_{0}^{d} ( z )} , & ( 3 ) \\ {λ}_{m} ( z ) = \sqrt{\frac{T ( z )}{{Z}_{o}^{u} ( z ) + {Z}_{0}^{d} ( z )}} , \\ and & ( 4 ) \\ {υ}_{0}^{d} ( z ) = - \frac{ ω {μ}_{0}}{{Z}_{0}^{d} ( z )} , & ( 5 )\end{matrix}$$

where Z₀^{a}(z) and Z₀^{d}(z) are the plane wave impedances for the upward and downward field propagation determined at depth z, T(z) is the “effective transverse resistance”, and 1/ν₀^{d}(z) is the “effective field penetration depth”. Function v₀(z) is the solution to the problem

∂_{z}²v₀(z)+iωμ₀σ(z)v₀(z)=0, v₀(0)=1, ∂_{z}v₀(0)=0, (6)

which is determined and continuous together with its first derivative in the conductive half-space z>0 with the conductivity distribution specified by function σ(z). For instance, in a homogeneous half-space, v₀(z)=cos h(z\sqrt{−iωμ₀σ}). In a stratified medium, the solution to problem (6) can be found using the well know iterative procedure. The terms included into equations (1) and (2) represent the leading asymptotic terms of the TE and TM-parts of the electromagnetic field. The terms characterized by the geometrical dependence on the horizontal separation r_{τ} correspond to the TE-field.

For a periodic HMD with the current moment m=mₓeₓ+m_{y}e_{y} located at the vertical axis of the coordinate system, the components of the electromagnetic field induced in the far zone of the source, are

$$\begin{matrix}{E}_{r} ( r ) = ω {μ}_{0} \{ {υ}_{o}^{d} ( z ) \frac{{λ}_{e}^{2} ( z )}{2 π {r}_{τ}^{3}} + \frac{{Z}_{0}^{u} ( z )}{2 π T ( z )} {K}_{1}^{′} ( \frac{{r}_{τ}}{{λ}_{m} ( z )} ) \} {m}_{ϕ} \\ {E}_{ϕ} ( r ) = ω {μ}_{0} \{ {υ}_{0}^{d} ( z ) \frac{{λ}_{e}^{2} ( z )}{π {r}_{τ}^{3}} - \frac{{Z}_{0}^{u} ( z )}{T ( z )} \frac{{λ}_{m} ( z )}{2 π {r}_{τ}} {K}_{1} ( \frac{{r}_{τ}}{{λ}_{m} ( z )} ) \} {m}_{r} \\ {E}_{z} ( r ) = - \frac{ ω {μ}_{0}}{σ ( z ) T ( z )} \frac{1}{2 π {λ}_{m} ( z )} {K}_{1} ( \frac{{r}_{τ}}{{λ}_{m} ( z )} ) {m}_{ϕ} , & ( 7 ) \\ {H}_{r} ( r ) ≃ + \{ {[ {υ}_{0}^{d} ( z ) ]}^{2} \frac{{λ}_{e}^{2} ( z )}{π {r}_{τ}^{3}} + \frac{ ω {μ}_{0}}{2 π T ( z )} \frac{{λ}_{m} ( z )}{{r}_{τ}} {K}_{1} ( \frac{{r}_{τ}}{{λ}_{m} ( z )} ) \} {m}_{r} \\ {H}_{ϕ} ( r ) ≃ - \{ {[ {υ}_{0}^{d} ( z ) ]}^{2} \frac{{λ}_{e}^{2} ( z )}{2 π {r}_{τ}^{3}} + \frac{ ω {μ}_{0}}{2 π T ( z )} {K}_{1}^{′} ( \frac{{r}_{τ}}{{λ}_{m} ( z )} ) \} {m}_{ϕ} \\ {H}_{z} ( r ) ≃ - {υ}_{0}^{d} ( z ) \frac{3 {λ}_{e}^{2} ( z )}{2 π {r}_{τ}^{4}} {m}_{r} , & ( 8 )\end{matrix}$$

where the magnetic moment of the HMD is expressed as m=mᵣeᵣ+m_{φ}e_{φ} and mᵣ=mₓ cos φ+m_{y} sin φ, m_{φ}=−mₓ sin φ+m_{y} cos φ.

From equations (1), (2), (7), and (8), the horizontal components of the electromagnetic field induced in a stratified formation by a HED or HMD are contributed by the TE-mode associated with the “airwave”, which is characterized by the geometrical 1/rᵣ³—dependance on the offset r_{τ}. Parameters (3) and (5) are largely unaffected by thin resistive layers that might be present in the subsea formation. So is the TE-mode of the induced, field and, consecutively, the airwave. On the other hand, the effective transverse resistance T(z), and, therefore, parameter (4) are directly contributed by the resistive layers. The non-geometric terms of equations (1), (2), (7), and (8) describe the asymptotic behavior of the TM-mode at large offsets. These terms are associated with the signature of deep resistive reservoirs. Due to the slower geometrical decay, the airwave masks the reservoir signature The geometric terms in the asymptotic expressions for the horizontal components of the electromagnetic, field are related to the leading asymptotic term of the vertical component of the magnetic field, which varies as 1/rᵣ⁴. Thus, elimination or suppression of the vertical component of the magnetic field is directly associated with suppression of the airwave at large offsets.

From equations (1), (2) and (7), (8), the horizontal components of the field induced by a source, which combines a HED with the current moment p and a HMD with the magnetic moment m, does not include the 1/rᵣ³—terms provided that

p=−ν₀^{d}(z)e_{z}×m (9)

or

pₓ=+ν₀^{d}(z)m_{y}. p_{y}=−ν₀^{d}(z)mₓ. (10)

If these conditions are satisfied, the 1/rᵣ⁴—term also disappears from the expression for the vertical component of the magnetic field induced by the combined source.

It should be noted that if the current moment of the source has a vertical component, it does not contribute to the TE-mode of the field induced in a stratified medium. If the magnetic. moment has a vertical component, its contribution to the TE-mode decays with the offset faster than the first asymptotic terms includes in equations (7) and (8). Therefore, a tilt of the current moment of the combined source and a limited tilt of the mapetic moment do not ruin the scheme.

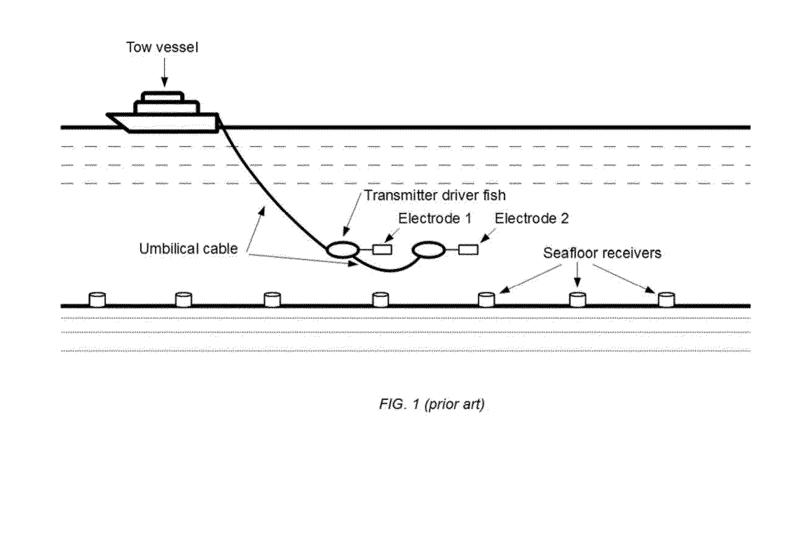

FIG. 1 shows the traditional deployment of a horizontal electric dipole type of the transmitter. The position of transmitter electrodes 1 and 2 may be controlled by a transmitter driver fish or fishes, from which the electrodes are deployed. The electric current fed via electrodes 1 and 2 is driven by a generator connected to the electrodes via an umbilical cable. As shown in the figure, the receivers are installed on the seafloor along a profile or they may cover some area of the sea floor.

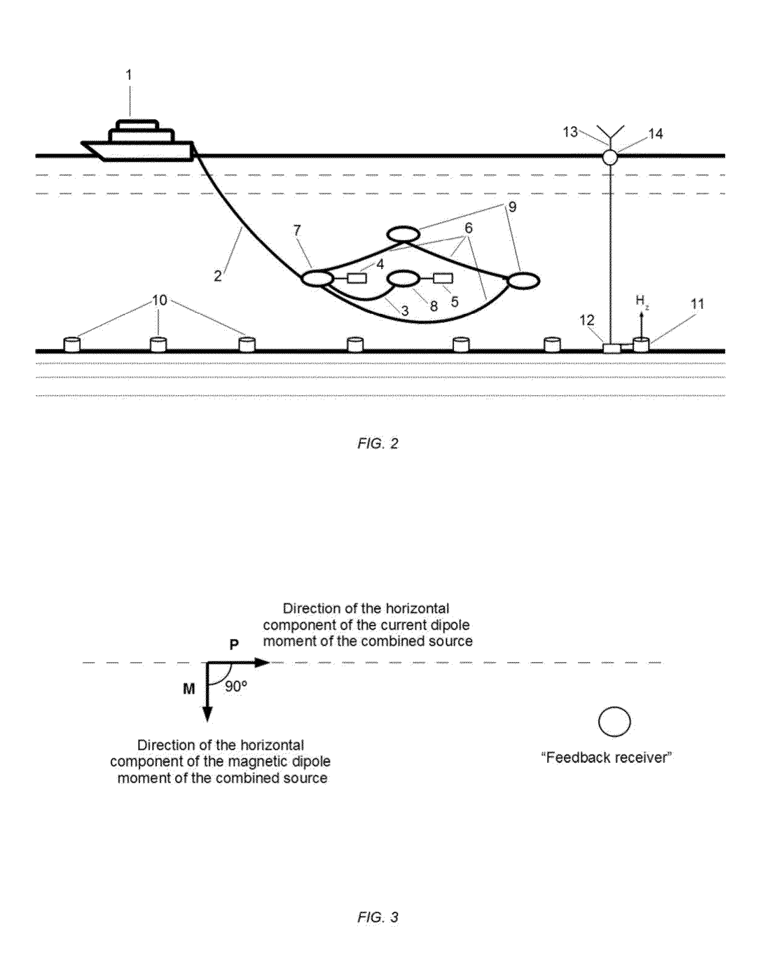

FIG. 2 shows, in accordance with one embodiment of the invention, a combined source consisting of an “electric dipole source” and a “magnetic dipole source”. The electric dipole source includes two electrodes 4 and 5, which are positioned at some depth above the seafloor and connected by the umbilical cable 2 to the power source located on the tow vessel 1. The cable is used for feeding the electric current to the electrodes and for the data transmission. The position of the electrode 4 is controlled by the transmitter driving fish 7, which also carries some of the power source generator components and is used to deploy the electrode 4. The second driver fish 8 is used to deploy and position the second electrode 5 of the “electric dipole source”; the electric current is fed to the electrode 5 via the umbilical cable 3. In this figure, the magnetic. dipole source represents a loop consisting of one or several turns of the cable 6, which is used to create a current loop and transfer the data. Additional transmitter fishes and/or auxiliary surface vessels 9 (the number of those as well as the connection to the power source on the tow vessel may differ) are used to position the loop. The magnetic dipole source may also represent a coil. For each of the operating frequencies used in the survey, the horizontal components of the effective current moment of the electric, dipole source and the horizontal component of the effective magnetic moment of the magnetic dipole source are mutually orthogonal and satisfy equation (9) or, which is equivalent, equation (10). The frequency dependent parameter ν₀^{d}(z) is determined by tuning up the transmitter to minimize the vertical component of the magnetic field measured by the remote “feedback” receiver 11 (or similar receivers) at each of the operating frequencies. When tuning up the transmitter the feedback receiver(s) should be located in the far zone of the transmitter. The feedback receiver(s) 11 can communicate with the transmitter control center on the tow ship 1 by the radio and acoustic means of communication, which may include the anchor and communication block 12, the aerial 13, and the buoy 14. The buoy may also carry the communication equipment. Other receiver stations 10 are positioned on the seafloor in accordance with the survey plan; they may include or not include sensors for acquisition of the vertical component of magnetic field in addition to sensors acquiring other field components.

Alternatively, for each of the operating frequencies, parameters ν₀^{d}(z) can be determined from equation (5) and complementary estimates of the plane wave impedance using one or several of the seafloor receivers allocated for the survey or using feedback receivers deployed specifically for this purpose. The corresponding data may be combined with the resistivity well logs if such logs are available. The complementary measurements are carried out prior to the main part of the survey using natural and/or controlled sources of the electromagnetic field.

FIG. 3 is the sketch of a plan view showing the mutual orientation of the “effective current moment” and the “effective magnetic moment” of the combined source in accordance with one embodiment of the invention, it also shows the position of the feedback receiver 11, which should be positioned off-line from the direction of the horizontal component of the effective current moment of the combined source and may be used to minimize the vertical component of the magnetic field at each of the operating frequencies used in the survey.

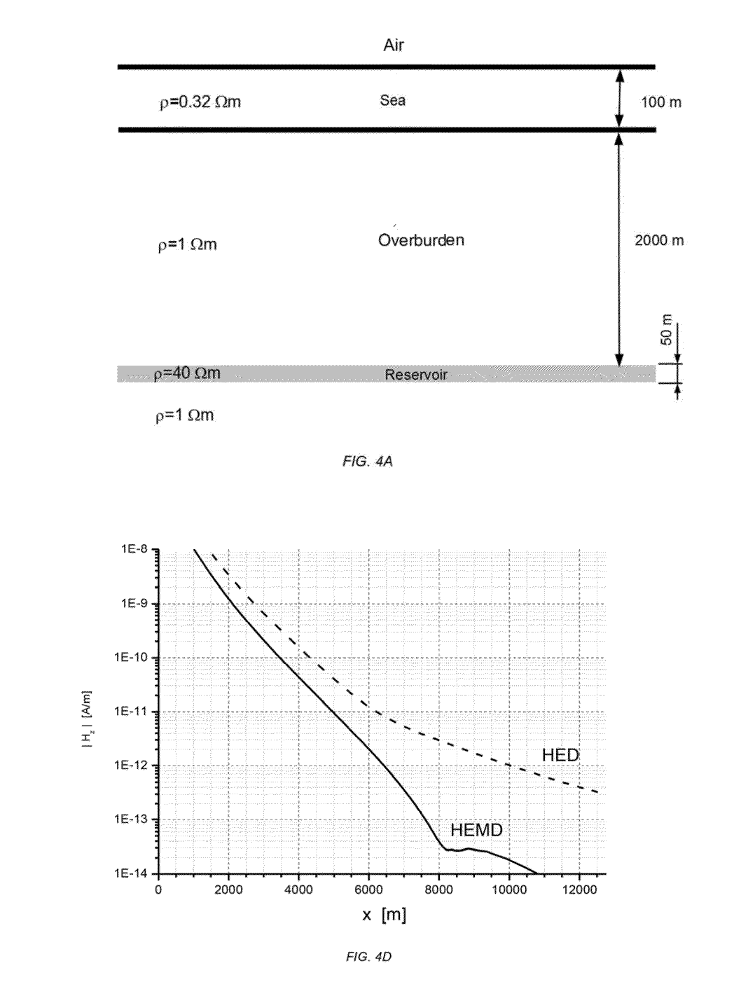

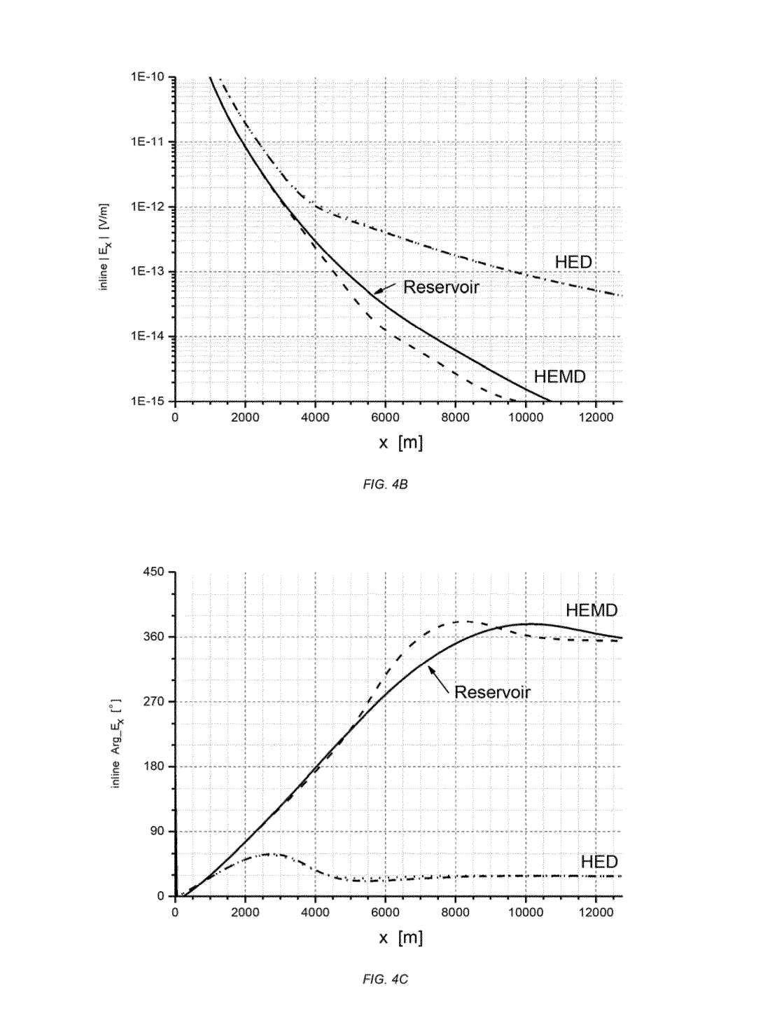

FIG. 4A shows a stratified earth model used to demonstrate the effect of the combined source in accordance with one embodiment of the invention. The upper layer of the conductive half-space represents the sea. The depth of the sea equals 100 m, the resistivity of the sea water is 0.32 Ωm. The target layer representing the hydrocarbon bearing reservoir is located, at the depth of 2000 m below the seafloor (not to scale). The thickness of this layer is 50 m, the resistivity equals 40 Ωm. The resistivity of other layers of the subsea formation is 1 Ωm.

FIGS. 4B and 4C show the amplitude and phase responses of two stratified models of the type shown in FIG. 4A: one of the models contains the reservoir, another model does not: the operating frequency equals 0.25 Hz. The responses are shown for two transmitter configurations. The first configuration (H ED) represents the traditional horizontal electric dipole directed along the survey profile, the current moment of this source equals 1 Am. The responses of the model free of the hydrocarbon bearing reservoir are shown by the doted curves. The responses of the model with the reservoir are shown by the dash-doted curves; they can hardly be distinguished from the corresponding responses of the model, which does not include the resistive layer. Another transmitter configuration (HEMD) includes the horizontal electric dipole with the current moment of 0.5 Am directed along the profile and a horizontal magnetic dipole orthogonal to it. The amplitudes and phases of the electric and magnetic dipoles satisfy equation (9). The responses of the model free of the reservoir are shown by the dashed curves. The amplitude and phase responses of the model containing the reservoir are shown by solid curves.

FIG. 4D shows the distribution of the amplitude of the vertical component of the magnetic field induced, along the profile shifted by 800 m away from the profile specified by the direction of the source current moment. The operating frequency equals 0.25 Hz. The dashed line shows the amplitude of the vertical component of the magnetic filed induced by a horizontal electric dipole (HED) with the current moment equal 1 Am in a model sketch in FIG. 4A; the solid curve shows the amplitude of the vertical magnetic field induced by the combined source (HEMD) with the current dipole moment equal 0.5 Am and the magnetic dipole moment specified by equation (9). The figure shows only one curve for each of the source configurations because the vertical component of the magnetic field is practically unaffected by the reservoir.

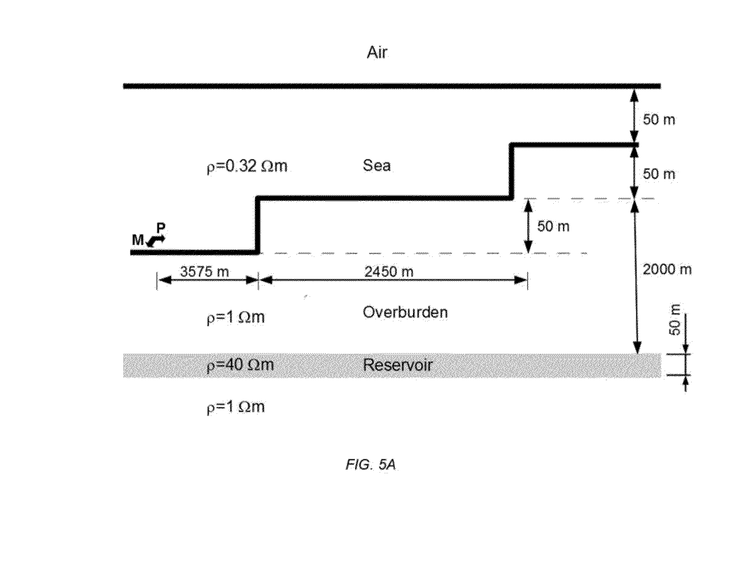

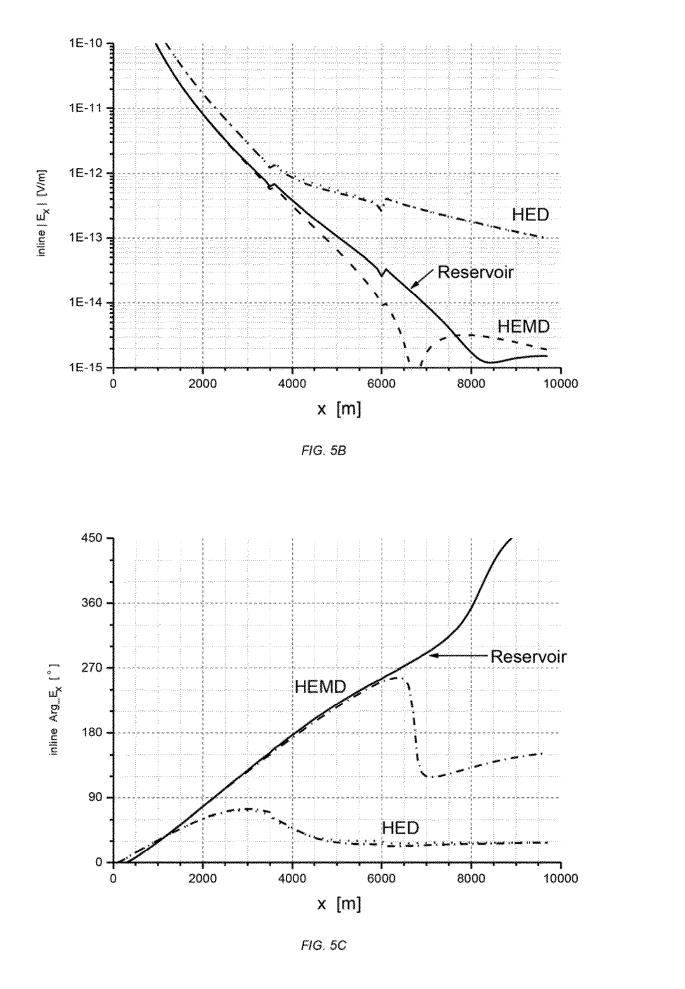

FIG. 5A shows a 2D earth model used to demonstrate the effect of the combined source in accordance with one embodiment of the invention. The upper layer of the conductive half-space represents the sea of variable bathymetry. The transmitter is located in the deepest part of the sea at the depth of 150 m. At the distance of 3575 m from the transmitter the depth of the sea reduces to 100 m, and 2450 m later it reduces to 50 m (not to scale). The resistivity of the sea water equals 0.32 Ωm. The target layer representing the hydrocarbon bearing reservoir is located at the depth of 2100 in below the surface of the sea. The thickness of the reservoir is 50 in, the resistivity equals 40 Ωm. The resistivity of other layers of the subsea formation is 1 Ωm.

FIGS. 5B and 5C show the amplitude and phase responses of two 2D models of the type shown in FIG. 5A; one of the model contains the reservoir, another model does not; the operating frequency equals 0.25 Hz. The responses are shown for two transmitter configurations. The first configuration (HED) represents the traditional horizontal electric dipole directed along the survey profile; the current moment of this source equals 1 Am. The responses of the model free of the hydrocarbon bearing reservoir are shown by the doted curves. The responses of the model with the reservoir are shown by the dash-doted curves; they can hardly be distinguished from the corresponding responses of the model, which does not include the resistive layer. Another transmitter configuration (HEMD) includes the horizontal electric dipole with the current moment of 0.5 Am directed along the profile and a horizontal magnetic dipole orthogonal to it. The amplitudes and phases of the electric and magnetic dipoles satisfy equation (9), in which parameter ν₀^{d}(z) corresponds to the 1D cross section of central part of the 2D model, where the depth of the sea equals 100 m. The responses of the model free of the reservoir are shown by the dashed curves. The amplitude and phase responses of the model containing the reservoir are shown by the solid curves.

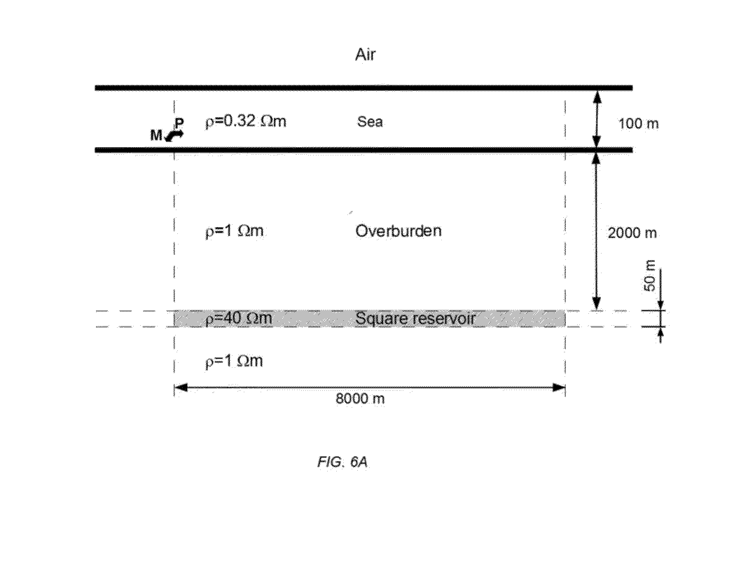

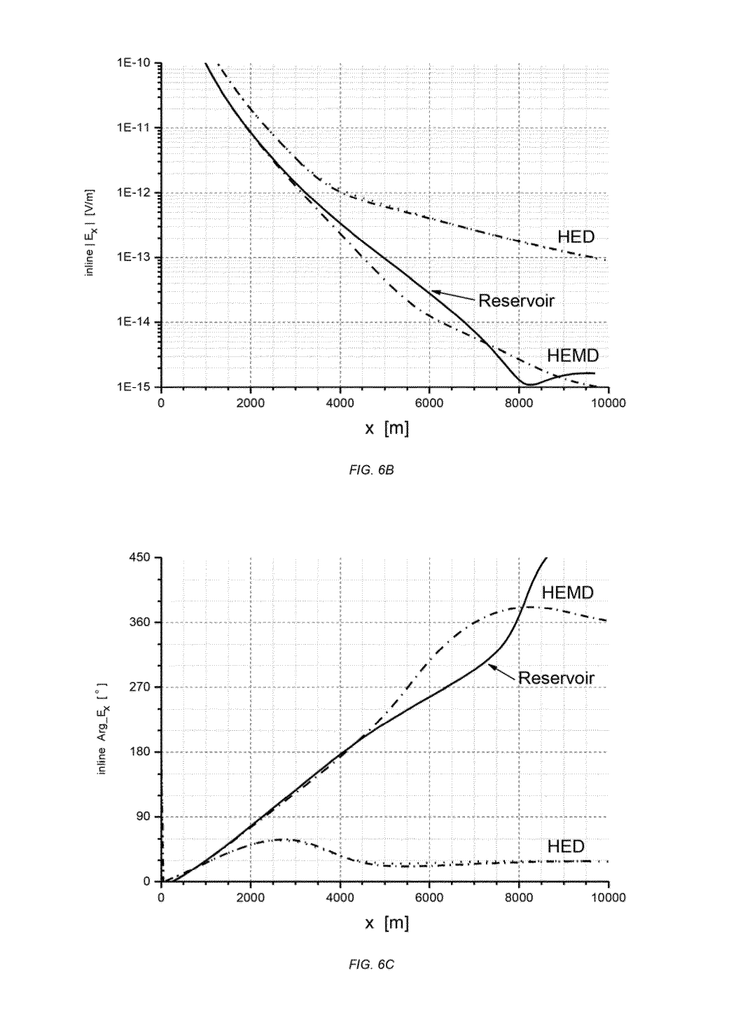

FIG. 6A shows a 3D earth model used to demonstrate the effect of the combined source in accordance with one embodiment of the invention. The upper layer of the conductive half-space represents the sea. The depth of the sea equals 100 in, the resistivity of the sea water is 0.32 Ωm. The hydrocarbon bearing reservoir is of a square shape with 8000 by 8000 m dimensions in the X and Y-directions. The reservoir is located at the depth of 2000 m below the seafloor, its thickness and resistivity are equal to 50 m and 40 Ωm, respectively. The resistivity of other layers of the subsea formation is 1 Ωm. The receivers are placed on the profile passing above the center of the reservoir in the X-direction. The transmitter is located on the same profile above the left edge of the reservoir.

FIGS. 6B and 6C show the amplitude and phase responses of the 3D formation shown in FIG. 6A and a stratified formation, which differs from that in FIG. 6A by absence of the reservoir. The responses at the operating frequency of 0.25 Hz are shown for two transmitter configurations. The first configuration (HED) represents the traditional horizontal electric dipole directed along the survey profile: the current moment of this source equals 1 Am. The responses of the stratified model free of the hydrocarbon bearing reservoir are shown by the doted curves. The responses of the 3D model, which includes the reservoir, are shown by the dash-doted curves; they can hardly be distinguished from the corresponding responses of the model, which does not include the resistive reservoir. Another transmitter configuration (HEMD) includes the horizontal electric dipole with the current moment of 0.5 Am directed along the profile and a horizontal magnetic dipole orthogonal to it. The amplitude and phase of the electric and magnetic dipoles satisfy equation (9), in which parameter ν₀^{d}(z) corresponds to the reservoir-free stratified model. The responses of the model free of the reservoir are shown by the dashed curves. The responses of the model containing the reservoir are shown by the solid curves.

From FIGS. 4B,C, 5B,C, and 6B,C, the use of the transmitter that combines an electric dipole source and a magnetic dipole source with the moments satisfying equation (9) significantly improves sensitivity of the measurement to thin resistive targets. From FIG. 4D, the far zone electromagnetic field of the combined source is characterized by a greatly reduced vertical component of the magnetic field.

While the invention has been described with respect to a limited number of embodiments, those skilled in the art, having benefit of this disclosure, will appreciate that other embodiments can be devised which do not depart from the scope of the invention as disclosed herein.

### Definitions Used to Formulate the Claims

Electric dipole includes two submerged electrodes, which together with connecting cables and a poser source are used to inject electric current to the sea; the electrodes may be positioned by special submerged devises (fishes). The principal characteristic, of the electric dipole is its current dipole moment, which represents a vector painting from the negative to positive electrode; the amplitude of the current dipole moment equals the product of the current injected into the water through the electrode by the distance between the electrodes.

Magnetic dipole represents a loop of cable or a coil, which together with connecting cables and a power source is used to drive electric current through the loop or coil without leaking the current into the sea; the loop or coil may be dynamically positioned by special submerged devises and/or auxiliary surface vessels. The principal characteristic of the magnetic dipole is its magnetic dipole moment, which is a vector pointing in the direction orthogonal to plane of the current loop; the amplitude of the magnetic dipole moment equals the product of the current flowing in the loop or coil by the total area encircled by the cable or coil turns.

Large horizontal separation from the transmitter (or large offset) is the horizontal transmitter-receiver separation, which significantly exceeds the depth of the field penetration into the formation, if the survey is carried out in the frequency domain, or the length of the field diffusion, if the survey is carried out in the time domain.

Remote receiver is a receiver, which is separated from the transmitter by a large offset.

What is claimed is:

1. A “Low-B_{z}” transmitter for marine electromagnetic, surveying or monitoring comprising:
an electric dipole combined with a magnetic dipole, which has the horizontal component of its magnetic dipole moment orthogonal to the direction of the horizontal component of the current dipole moment of the electric dipole, and which varies in time in accordance with the law assuring suppression of the vertical magnetic field at large horizontal separations from the transmitter either within the operational time window or at each operating frequency chosen for surveying.

2. A method of marine electromagnetic surveying or monitoring using receivers of the electric and/or magnetic fields acquiring components of the electromagnetic field induced by a “low-B_{z}” transmitter of claim 1.

3. A method of marine surveying or monitoring, and processing of the electric and/or magnetic fields comprising:
acquisition of at least two sets of electromagnetic data such that positions of the transmitter and receivers when acquiring the second set of data are the same or close to the corresponding transmitter and receiver positions when acquiring the first set of data; during acquisition of the first set of data the transmitter may represent an electric dipole, then during acquisition of the second set of the data the transmitter represents a magnetic dipole with the direction of the horizontal component of its magnetic dipole moment being orthogonal to the direction of the horizontal component of the current dipole moment of the transmitter when acquiring the first set of data; after full or partial completion of the measurements the sets of the electromagnetic field data acquired for the same or close transmitter and receiver positions are linearly combined, in a way permitting suppression of the combined vertical magnetic field at large offsets.

4. A method of marine electromagnetic surveying or monitoring in which tuning up the “Low-B_{z}” transmitter of claims 1 and 2 is achieved within the operational time window or at each operating frequency by measurement of the vertical component of the magnetic field at a receiver or receivers located in a reasonable proximity to the area of interest but at a large horizontal separation from the transmitter and by subsequent adjustment of the current dipole moment of the electric dipole and the magnetic dipole moment of the magnetic dipole of the “Low-B_{z}” transmitter of claim 1 in a manner allowing for suppression of the vertical magnetic field at these receivers.

5. A method of marine electromagnetic surveying or monitoring in which the tuning up the “Low-B_{z}” transmitter of claims 1 and 2 is carried out using the plain wave impedance or a related transfer function evaluated for one or several locations; the evaluation of the plain wave impedance or the related transfer function is carried out from measurements of the electromagnetic fields induced by natural and/or controlled sources and/or from the borehole resistivity logs acquired in a reasonable proximity to the area of interest.

6. A method of marine electromagnetic surveying or monitoring in which the transmitter or transmitters of claim 1, 2, 3, 4, or 5 are either stationary or towed behind a vessel or vessels.

7. A method of marine electromagnetic surveying or monitoring in which the receiver or receivers of claim 2, 3, 4, or 5, are either stationary or towed behind a vessel.

8. An apparatus to survey the subterranean formations, comprising:
a “Low-B_{z}” transmitter of claim 1, cables connecting this transmitter to the power source located on the vessel or otherwise, a set of receivers registering components of the electromagnetic field, the transmission, acquisition, and positioning controlling hardware and software, and a system to process the acquired signals and generate a representation of the subterranean formation.

9. A method of marine electromagnetic surveying or monitoring in which information on the subsea formation or its part is implicitly or explicitly using data acquired in a survey with a “Low-B_{z}” transmitter of claim 1 or the combined data of claim 3.
